(19) United States
(12) Patent Application Publication
(10) Pub. No.: US 2016/0364694 A1
(43) Pub. Date: Dec. 15, 2016

(54) QUANTIFYING QUALITY TIME

(71) Applicant: Vivint, Inc., Provo, UT (US)

(72) Inventor: Harrison Jenkins, Salt Lake City, UT (US)

(21) Appl. No.: 14/736,930

(22) Filed: Jun. 11, 2015

(51) Int. Cl. G06Q 10/10; G06Q 10/06

(52) U.S. Cl. CPC G06Q 10/1093; G06Q 10/06395

(57) ABSTRACT

Systems and methods for quantifying quality time are described. A network of at least two individuals may be created. An amount of time the individuals are within a predetermined proximity of each other may be recorded. It may be determined whether the individuals are participating in a preferred activity of at least one of the individuals during the time the individuals are within the predetermined proximity of each other. A score may be generated based at least in part on the amount of time recorded and the preferred activity and the score may be transmitted to at least one individual of the network.

### BACKGROUND

People are constantly running from one event to another or are spending too much time at work. People become focused on the minutia of life that they forget to stop and enjoy the time they have with other loved ones. Often times people have a hard time prioritizing properly and fitting time for family and friends into their busy schedule.

With the wide-spread use of computers and mobile devices has come an increased presence in the use of technology in everyday life. Many people use technology to program and control their life. Users of technology continue to demand new methods and ways of using the technology to simplify and clarify their lives. Improving scheduling and prioritizing is desirable to those who wish to spend more time with their family and other loved ones.

### SUMMARY

According to at least one embodiment, the computer-implemented method may include creating a network of at least two individuals. The method may include recording an amount of time the individuals are within a predetermined proximity of each other. In some embodiments, the predetermined proximity may be approximately 0.25 miles. The method may include determining whether the individuals are participating in a preferred activity of at least one of the individuals during the time the individuals are within the predetermined proximity of each other. The method may include generating a scored based at least in part on the amount of time recorded and the preferred activity and transmitting the score to at least one individual of the network.

In some embodiments, creating the network of at least two individuals may further include identifying at least two individuals and registering a GPS-enabled device associated with each individual. In some embodiments, the GPS-enabled device may be one of a mobile phone, wearable device, or a tablet.

In some embodiments, the computer-implemented method may further include determining whether the individuals are at a preferred location of at least one of the individuals. The method may generate a second score based at least in part on the preferred activity, the preferred location and the amount of time recorded. The method may transmit the second score to at least one of the individuals in the network.

In some embodiments, the computer-implemented method may determine if the at least two individuals are communicating. The method may generate the score base additionally on the communication between the individuals. In some instances, the communication may be one of a phone conversation, SMS conversation, email conversation, social media communication or face-to-face conversation. In some embodiments, the generated score may be reduced when the at least two individuals are not within the predetermined proximity of each other.

In some embodiments, the computer-implemented method may receive goals from at least one of the individuals. The goals may be based at least in part on scores the individual wishes to receive. In some instances, the method may generate a report comparing the goals of the individual with the generated scored and transmit the report to the individual.

According to another embodiment, the at least two individuals may be members of a family-unit. In some embodiments, the network may comprise more than two individuals and each individual that is a part of the network is part of a family-unit. In some embodiments, the generated score may be additionally based on the number of individuals in the family-unit that are within the predetermined proximity of each other.

According to another embodiment, an apparatus for quantifying time spent with individuals is also described. The apparatus may include a processor, a memory in electronic communication with the processor and instructions stored on the memory of the processor. The processor may execute the instructions to create a network of at least two individuals and record an amount of time the individuals are within a predetermined proximity of each other. The processor may further include instructions to determine whether the individuals are participating in a preferred activity of at least one of the individuals during the time the individuals are within the predetermined proximity of each other and generate a score based at least in part on the amount of time recorded and the preferred activity. The processor may also include instructions to transmit the score to at least one individual in the network.

In some embodiments, the score may be sent as one of an email, SMS message, phone call or social media post. In some instances, participating in a preferred activity may further include being at a preferred location of one of the individuals. In some embodiments, the predetermined proximity is approximately 0.25 miles.

According to another embodiment, a computer-program product for quantifying time spent with individuals is also disclosed. The computer-program product may include a non-transitory computer-readable medium that may store instructions executable by a processor. The instructions may create a network of at least two individuals and record an amount of time the individuals are within a predetermined proximity of each other. The instructions may further determine whether the individuals are participating in a preferred activity of at least one of the individuals during the time the individuals are within the predetermined proximity of each other and generate a score based at least in part on the amount of time recorded and the preferred activity. The instructions may also transmit the score to at least one individual in the network.

The foregoing has outlined rather broadly the features and technical advantages of examples according to the disclosure such that the following detailed description may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the embodiments may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of an environment in which the present systems and methods may be implemented;

FIG. 2 is a block diagram of an example quality time capture module of the environment shown in FIG. 1;

FIG. 3 is a block diagram of an example quality time measurement module of the environment shown in FIG. 1;

FIG. 4 is a block diagram of an example metrics module of the environment shown in FIG. 3;

FIG. 5 is a flow diagram illustrating a method of quantifying quality time;

FIG. 6 is a flow diagram illustrating another method of quantifying quality time; and

FIG. 7 is a block diagram of a computer system suitable for implementing the present systems and methods of FIG. 1.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The systems and methods described herein relate to quantifying the amount of time spent with individuals. More specifically, the systems and methods described herein related to an automated system for tracking and quantifying the quality and quantity of time spent a user spends with his friends and family members. In one example, a device may track and record information regarding an experience with a family member or friend. In some cases, this information may be ascertained in a scoring module and enable an individual to record metrics and meet goals.

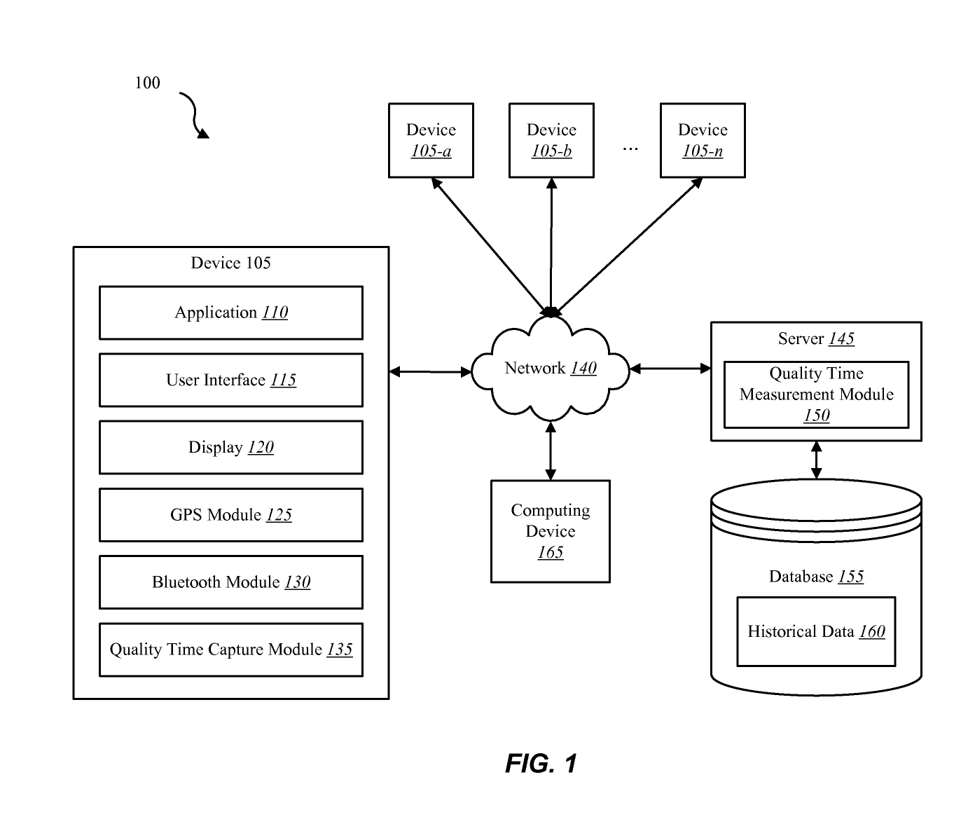

FIG. 1 is a block diagram illustrating one environment on which the methods and disclosure may be implemented. The environment 100 may include a device 105, a network 140, and a server 145. The environment may additionally include multiple devices 105-a, 105-b, . . . 105-n, as well as a computing device 165.

The device 105 may include an application 110, a user interface 115, a display 120, a GPS module 125, a Bluetooth module 130, and a quality time capture module 135. The application 110, user interface 115 and display 120 may all enable a user to interface with the device 105. The GPS module 125 may be a logging GPS module or a pusher GPS module and may track the location of the device 105. For example, the GPS module 125 may log the physical location of the device 105 and send a log to the server, or the GPS module 125 may continuously push geographic information to either the server 145, the computing device 165 or both. The Bluetooth module 130 may be a wireless technology standard for exchanging data over short distances. In some instances, the Bluetooth module 130 may allow the devices 105-105-n to communicate and directly interact with each other. In some embodiments, the device 105 may include one or more processors, one or more memory devices, and/or a storage device. Examples of the device 105 may include smart wearable devices, mobile devices, smart phones, personal computing devices, computers, servers, etc.

In some instances, the device 105 may connect to the computing device 165 or the server 145 over the network 140. Examples of the network 140 may include cloud networks, local area networks (LAN), wide area networks (WAN), virtual private networks (VPN), wireless networks (using 802.11, for example), and/or cellular networks (using 3G and/or LTE, for example), etc. The network 140 may be a single network, or may include multiple interconnected, overlapping, or coincidental networks. For example, in some embodiments, the network 140 may include multiple networks interconnected to facilitate communication or may include redundant networks. For example, the network 140 may represent a first network (e.g., the Internet) and a second network (e.g., cellular networks).

The server 145 and the computing device 165 shown in FIG. 1 may represent one or more separate servers/computing devices or a combination of such. Examples of the computing device 165 may include a personal computing device (e.g., laptop, desktop, etc.), a mobile computing device (e.g., tablet computing device, smartphone, etc.), a server (e.g., enterprise server, cloud server, etc.) and the like. In some embodiments, the server 145 may be an additional computing device or may be a separate server with its own software. In some embodiments, the server 145 may be representative of peer-to-peer networking or file sharing. In some embodiments, the server 145 may include a quality time measurement module 150. The quality time measurement module 150 may quantify the quality time a user spends with other individuals within the environment 100.

The server 145 may be connected to a database 155. The database may include, for example, historical information regarding the device 105. For example, the database 155 may include a historical database 160 which may contain information pertaining to each device in the environment 100 (e.g., device 105, 105-a, 105-b, 105-n). For example, the historical database 160 may store all of the tracking information relating to the devices 105-105-n and may also store scoring information, reports, network information, user preferences, etc. The database 155 may include other information including, for example, contact information for the user and other individuals in the environment 100, other aspects of environment 100, and the like.

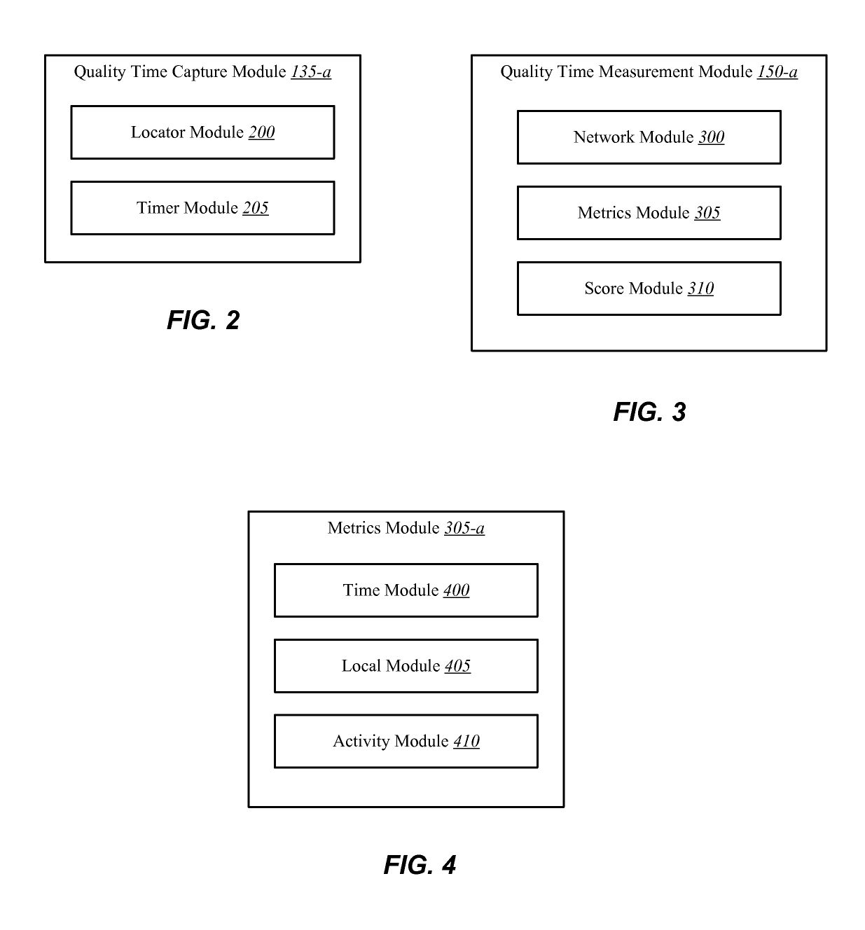

FIG. 2 is a block diagram illustrating one embodiment of a quality time capture module 135-a. The quality time capture module 135-a may be one example of quality time capture module 135 shown in FIG. 1. In some embodiments, the quality time capture module 135-a may comprise a locator module 200 and a timer module 205. The quality time capture module 135-a may include additional modules or capabilities in other embodiments. Similarly, the quality time capture module 135-a may include a fewer number of modules and functionalities than that which is described with references to FIG. 2.

In some embodiments, the locator module 200 may determine a location of a user. For example, the locator module 200 may track a location of a device (e.g., device 105) associated with a user and therefore determine a location of the user. The locator module 200 may determine the geographical coordinates of the device (i.e., the latitude and longitudinal location of the device 105). In other embodiments, the locator module 200 may interpret the geographical coordinate information to determine a more specific location of the device. For example, the locator module 200 may determine the geographical coordinates of the device are associated with a particular shopping mall, museum, amusement park, etc. In other embodiments, the locator module 200 may be attuned to a social media post associated with the user. For example, the user may post to a social media site and “check-in” to a specific location. The locator module 200 may gather that information and determine where the user is located.

In other embodiments, the locator module 200 may determine the user is moving. For example, the locator module 200 may determine the device is in motion and the geographical region of the device is a ski mountain. Therefore, the locator module 200 may assume the user is skiing. In another embodiment, the locator module 200 may determine the device 105 is moving at a certain speed down a known trail. The locator module 200 may determine, based on the speed and the location, that the user is hiking, biking, or running down a particular trail. The locator module 200, in some instances, may also track a proximity of the device to other devices in the environment, for example, the environment 100 and at least one of the devices 105-a, 105-b, 105-n. The other devices may be associated with individuals known by the user. The individuals may be a part of the user's network and/or otherwise associated with the user.

In some embodiments, the timer module 205 may determine a length of time the user and at least one other individual are within a predetermined proximity of each other. For example, the locator module 200 may determine the user's device (e.g., device 105) is within a predetermined proximity of a first individual's device (e.g., device 105-a). The locator module 200 may prompt the timer module 205 to begin timing and record the length of time the devices are within the predetermined proximity. The timer module 205 may only track the time when the devices are within a predetermined proximity or, in some instances, it may track an aggregate time the devices are within a predetermined proximity. For example, the devices may be located at a mountain resort where the users are skiing. At some point, the devices may briefly be outside the predetermined proximity. The timer module 205 may ignore the brief respite and continue to record the aggregate amount of time the devices are located within the same area.

In some embodiments, the predetermined proximity may be a distance. For example, the predetermined proximity may be approximately ½ mile, ¼ mile, 1/10 mile or 100 yards. In other embodiments, the predetermined proximity may be defined by geo-fencing. For example, the devices may both be within a geographic area bounded by a virtual perimeter known as a geo-fence. The geo-fence may define a location such as a park, mall, resort, etc. The geo-fence may define the predetermined proximity the timer module 205 may use to track and record time.

In other embodiments, the predetermined proximity may be tracked by Bluetooth range. For example, both devices may be equipped with a Bluetooth module (e.g., Bluetooth module 130). The Bluetooth modules may be programmed such that the devices may connect when within Bluetooth range of each other. The timer module 205 may begin recording the amount of time the devices are connected via a Bluetooth connection. Using a Bluetooth connection may preserve battery life by preventing the devices from running a GPS module and using various supportive networks to track a geographical location.

FIG. 3 is a block diagram illustrating one embodiment of a quality time measurement module 150-a. The quality time measurement module 150-a may be one example of the quality time measurement module 150 shown in FIG. 1. In some embodiments, the quality time measurement module 150-a may include a network module 300, a metrics module 305, and a score module 310. The quality time measurement module 150-a may include additional modules or capabilities in other embodiments. Similarly, the quality time measurement module 150-a may include a fewer number of modules and functionalities than that which is described with references to FIG. 3.

In some embodiments, the quality time measurement module 150-a may include a network module 300. The network module 300 may create a network of individuals. For example, a user may wish to quantify the time he spends with other individuals. The individuals may be a single individual, a group of individuals or several groups of individuals. For example, the individuals may be a spouse, family-unit, friends, extended family, etc. In order to track the time spent with others, the user may create a network of individuals. The network module 300 may receive the request and create a network.

The request may include a variety of information. For example, a user may send a request to the network module 300 containing an individual's name and contact information as well as a relationship identifier. The relationship identifier may define a relationship between the user and the individual. For example, the relationship identifier may be “spouse,” “child,” “mother,” “friend,” etc. The relationship identifier may allow the network module 300 to correctly categorize, prioritize and place the individual in the correct group. For example, a user may quantify quality time spent with multiple groups of individuals and therefore may have different groups created in his network. The groups may include “spouse,” “family,” “friends,” “co-workers,” and the like. The relationship modifier may appropriately place the individual in the correct group and allow the system to properly quantify quality time with the individual. In other embodiments, the request may simply contain a piece of contact information for the individual. The individual may then specify the information such as his name and a relationship identifier.

The network module 300 may process the request from the user and send a subsequent request to the individual. The subsequent request may ask the individual to be added to the user's network. If the individual agrees to be added, the network module 300 may register a GPS-enabled device associated with the individual. For example, the network module 300 may receive information from the individual regarding contact information for a GPS-enabled device. The GPS-enabled device may be an example of one of the devices 105-a, 105-b, . . . 105-n shown in FIG. 1. Registering the GPS-enabled device may include downloading or otherwise installing a quality time capture module (e.g., quality time capture module 135) on the device.

In some embodiments, the subsequent request may also query the individual for more information. For example, the subsequent request may ask the individual to identify locations or activities the individual prefers. In some embodiments, the individual may select locations or activities from a drop-down list. In other embodiments, the individual may enter in the locations or activities they prefer. In further embodiments, the individual may enter a favorite pastime with the user. For example, a son's favorite activity may be attending a Red Sox game with his father (the user). In some embodiments, the user may receive a report of the preferred activities and locations of the individual. The process of adding an individual may repeat as the user continues to build and develop his network.

The metrics module 305 may be configured to capture and quantify data relating to the user spending time with the individual. For example, as shown in FIG. 4, a metrics module 305-a may include a time module 400, a local module 405, and an activity module 410. The metrics module 305-a may be one example of the metrics module 305 shown in FIG. 3. The metrics module 305-a may include additional modules and capabilities in other embodiments. Similarly, the metrics module 305-a may include a fewer number of modules and functionalities than that which is described with reference to FIG. 4.

In some embodiments, the time module 400 may receive information from the timer module 205. For example, in some embodiments, the device 105 may communicate with the server 145 over the network 140 and may send time information from the timer module 205 to the time module 400. In other embodiments, the time module 400 may track and record the time the devices, and therefore the user and individuals, are within the predetermined distance. It may record time based on a running basis. For example, it may begin a timer when the devices are first within the predetermined distance of each other and stop the timer when the devices are no longer within the predetermined distance of each other. In other embodiments, the time module 400 may receive GPS information with time stamps. The time module 400 may examine, analyze, and extrapolate information to determine an overarching amount of time the devices were either within the predetermined proximity, geo-fence location, or the Bluetooth range.

The local module 405 may coordinate with the time module 400 to determine a location where the devices, and therefore the group, were spending time together. For example, the locator module 200 may send location information such as GPS coordinates to the local module 405. The local module 405 may use the coordinates to determine a location of the devices. The local module 405 may determine a generic location such as a shopping mall, a park, the user's home, a sports arena, a ski mountain, the zoo, etc. In other embodiments, the local module 405 may determine a specific location, such as Nordstrom's, the Natural History Museum, Fenway Park, the Smithsonian Zoo, etc. In some embodiments, the local module 405 may determine the location of the user and the individuals is a preferred or favorite location of the individual.

In some embodiments, the activity module 410 may use the information gathered by the local module 405 to determine what activity the user and individual are participating in. For example, the activity module 410 may determine the group is at a ski mountain and deduce the group is skiing, or it may determine the group is at a mall and therefore shopping. In still further examples, the activity module 410 may determine the group is at Disney World and is vacationing. In other embodiments, the activity module 410 may be linked to a social media site associated with either the user or one of the individuals. The activity module 410 may interpret social media posts by either the user or individual to determine the activity. For example, the individual may post a photo of the individual and the user with the captain “Hiking Zion National Park.” The activity module 410 may determine that the group is in fact in Zion National Park and therefore hiking. The activity module 410 may further determine the activity is a preferred activity of one of the individuals.

Referring back to FIG. 3, the score module 310 may receive information from the metrics module 305 and quantify the experience of the user and the individual(s). For example, the score module 310 may quantify the time the group spent together by using various factors to determine a score. The factors may include at least one of a length of time spent together, a location where time was spent together, and/or the activity engaged in. The factors may also include additional factors to quantify the experience such as number of individuals together or the specific group of individual together, for example, if the family-unit is spending time together. In some embodiments, the factors may be weighted differently such that a weighted score is produced.

In some embodiments, multiple scores may be generated. For example, a first score may quantify time and activity. A second score may factor in time, activity, and preferred location. In other embodiments, the score may be weighted such that when the user partakes in a preferred activity of one of the individuals, the score is increased by a set amount. In other embodiments, the score may increase if the user is at a preferred location of one of the individuals.

In some embodiments, the score module 310 may transmit the score to the user. For example, the score module 310 may generate a report that may contain one or several scores that quantify the amount of time the user spent with an individual or group of individuals. The report may include simply the scores associated with a specific individual, or with a group of individuals, or with the user's entire network. The report may include the scores, or in some instances, it may additionally include the metadata used to generate the scores. For example, the report may include the time information, the location information and the activity information recorded for a certain time period. In some embodiments, the report may contain a hyperlink which may allow the user to amend, modify, or delete any information contained within the report. In other embodiments, the hyperlink or additional hyperlinks may allow the user to add information not contained in the report. For example, a father may have spent time reviewing homework with his child. Because this occurred at a home location, the quality time measurement module 150-a may not have recorded it as quality time, but it may be important for the father to track such time. Therefore, the father may manually add additional time to his log and receive a score and report on the manually added activity.

In additional embodiments, the report may compare the score with a goal set by the user. For example, the user or individuals may set a goal of time and/or weighted score to spend with either a specific individual, or with a group of individuals. For example, a husband may set a goal to spend five hours with his spouse every week. This may include going on a date, shopping together, or just general time spent together. The couple may have children. The father may set a goal of how much time to spend with each child and/or with the group of children. The goals may be daily, weekly, monthly, and/or annual goals. The goals may also include attending events associated with children (e.g., dance recitals, sports games, science competitions, etc.). In some embodiments, the goals may include eating meals with the family or taking time to spend with the family (e.g., family vacations, family outings, etc.). In such embodiments, the report may compare actuals to the goals set forth.

In some embodiments, the score module 310 may generate and send the report at preset time intervals. The preset time intervals may be default intervals or may be specified by the user. The preset time intervals may also be specific to individuals or to groups. For example, the user may wish to receive information regarding the time spent with his spouse every day. In other embodiments, the user may wish to receive reports on his family daily, bi-weekly, bi-monthly, etc. In some embodiments, the report may also include a summary for the week. For example, while the user may elect to receive daily reports, weekly and/or monthly summaries may also be generated and distributed to the user. In some embodiments, the reports may be sent to all individuals. The individual(s) may determine the frequency of the report, or the frequency may be determined by the user.

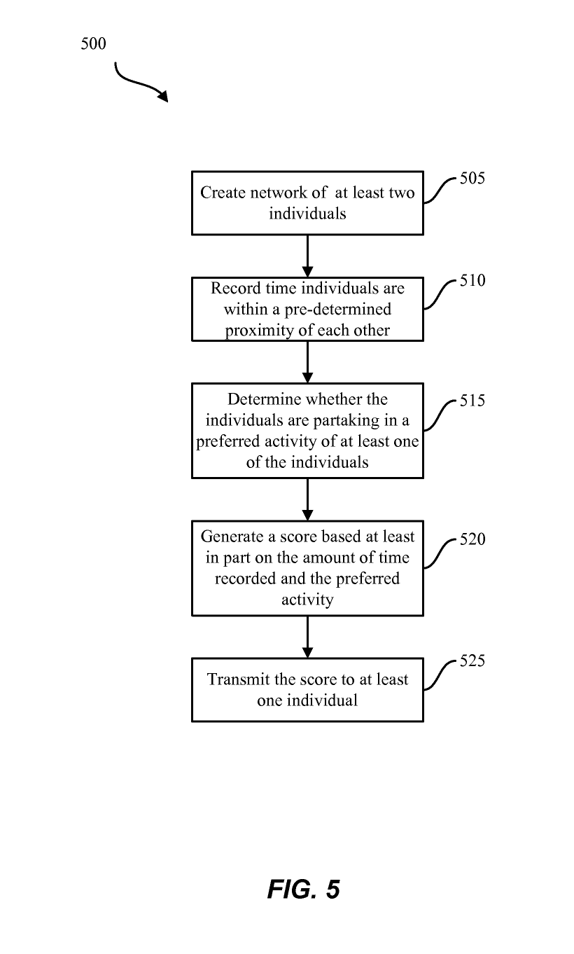

FIG. 5 is a flow diagram illustrating one embodiment of a method 500 for quantifying time. In some configurations, the method 500 may be implemented in whole or in part by one of the quality time capture module 135, the quality time measurement module 150 or both. The method 500 may include fewer or additional steps than those illustrated in FIG. 5.

At block 505, a network of at least two individuals may be created. At block 510, the time the individuals are within a predetermined proximity of each other may be recorded. At block 515, it may be determined whether the individuals are participating in a preferred activity of at least one of the individuals. At block 520, a score may be generated based at least in part on the amount of time recorded and the preferred activity. At block 525, the score may be transmitted to at least one individual in the network of individuals.

In some embodiments, at block 505, a network of at least two individuals may be created. For example, at block 505, a request from a user to create a network may be received. The user may request to add an individual to his network. In some embodiments, the network may be a group of individuals the user wishes to track and record the amount of time spent with. The network may consist of a single individual or several individuals. The individuals may be categorized or may belong in different groups (e.g., family, friends, relatives, etc.).

In some embodiments, at block 510, the time individuals are within a predetermined proximity of each other may be recorded. For example, a location of the at least two individuals may be tracked and a timer may start when the individuals are within a predetermined proximity of each other. The predetermined proximity may be defined by a distance, by a location or by Bluetooth range. For example, each individual may have a GPS-enabled and Bluetooth-enabled device. The devices may be configured such that when they are within a predetermined proximity, the devices may connect via a Bluetooth connection. In those instances, the timer may choose to only run when the devices are within connected via the Bluetooth connection.

In some embodiments, at block 515, an activity the individuals are participating in may be determined. For example, a geographical location of the at least two individuals may be determined. In some embodiments, the location may be determined via a geographical location (e.g., longitude and latitude coordinates) of the group. The geographical location, in some instances, may be determined by a GPS module (e.g., GPS module 125), a locator module (e.g., locator module 200), a local module (e.g., a local module 405), or in some embodiments, a social media post. In other embodiments, at block 515, the activity of the at least two individuals may be determined via an activity module (e.g., activity module 410).

In some embodiments, at block 520, a score may be generated. The score may be based at least in part on the amount of time recorded and the activity of the at least two individuals. For example, in some embodiments, In some embodiments, the score may be a weighted score. For example, different factors may have different importance levels. The importance levels may be inherent or default within the method 500. In other embodiments, the importance of the factors may be determined by the user. For example, in some embodiments, the user may wish to spend more time with his family doing child oriented activities. Therefore, he may choose that activities relating to his children receive a higher importance than non-children centric activities. For example, the zoo may be a preferred location of a child. If a parent spends time with this child at the zoo, the weighted score may take into account not only the time the parent spent with this child, but also the fact that the time was spent at one of the preferred locations of the child. In other embodiments, a user may wish to spend more time with his family. In those instances, the user may wish to give greater importance to the length of time the user spends with his family.

Once the score is generated, in some embodiments, at block 525 the score may be transmitted to at least one of the individuals. For example, the score may be sent to at least one of the individuals via an SMS message, email, phone call, social media post, or the like. The individual receiving the score may specify how they wish to receive the score, or it may be sent via a default method (e.g., an email). In some embodiments, the user may receive the score in various forms, for example, the user may receive both an SMS message and a social media post.

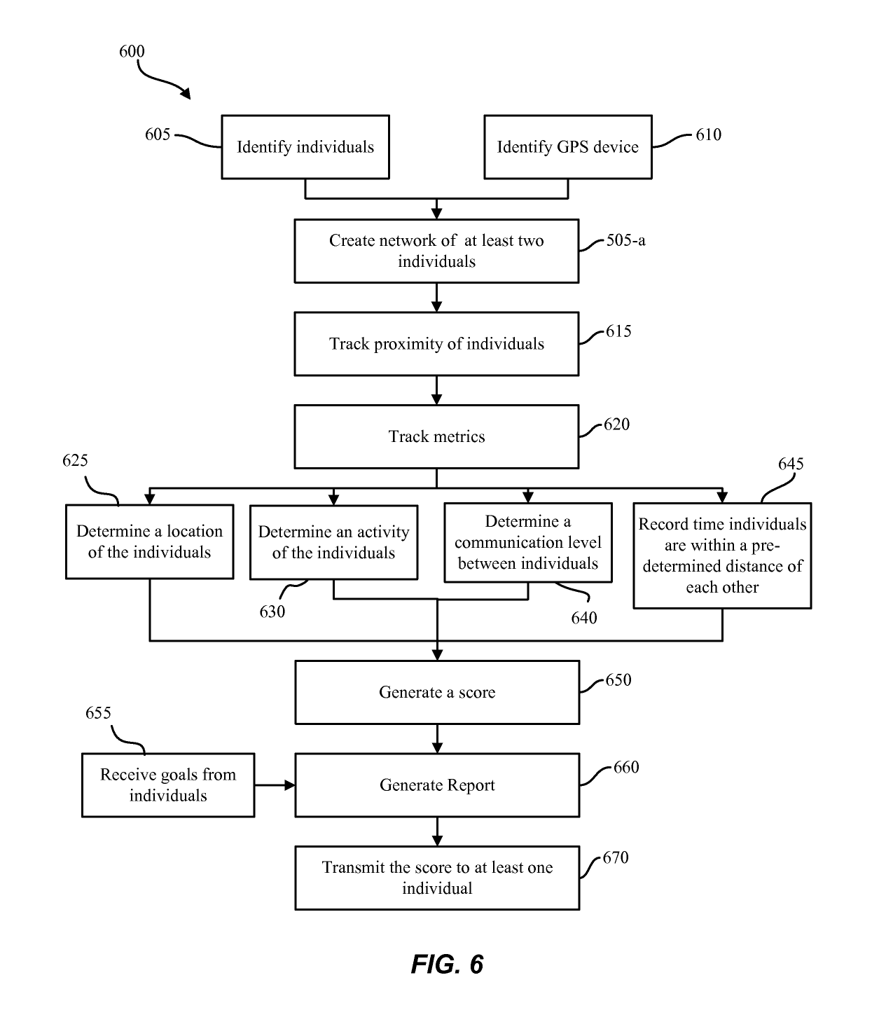

FIG. 6 is a flow diagram illustrating an embodiment of another method 600 for quantifying the amount of quality time a user may spend with individuals. In some configurations, the method 600 may be implemented in whole or in part by one of the quality time capture module 135, quality time measurement module 150, or both. In alternative embodiments, the method 600 may include more or fewer steps than those illustrated in FIG. 6.

In some embodiments, at block 605, individuals may be identified. For example, a user may wish to create a network of individuals. The individuals may be people the user wishes to spend more time with, or, the user may simply wish to track the time he does spend with select individuals. The individuals may be anyone of importance to the user. For example, in some embodiments, the user may only wish to track “family time,” or the time the user spends with his family. In other embodiments, the user may wish to see more of his friends and want to make a point to stay in touch with them. The user may add his friends to his network by identifying and requesting to add them to his network.

In some embodiments, at block 610, a GPS-enabled device associated with the individuals may be identified. For example, when the user identified individuals to add to his network, the user may have included contact information for the individual(s). Via the contact information, the individual may identify their GPS-enabled device and associate it with a network relating to the user. For example, the user may have requested to add an individual to his network and may have provided a mobile phone number. The individual may have received an SMS message requesting to add the individual to the user's network. The request may allow the individual to register their mobile phone, which may have a GPS module (e.g., GPS module 125), with the user's network.

Then, in some embodiments, at block 505-a, a network of at least two individuals may be created. In some embodiments, the network may include more than two individuals. For example, the network may include a group of people or multiple groups of people. For example, the user may create multiple groups in his network. The groups may consist of a family-unit which incorporates his spouse and children, a friends group, an extended family group, etc. In some embodiments, the user may request the group to add the individual to. In other embodiments, the user may specify a relationship identifier that may appropriately place the individual in the accurate group.

In some embodiments, at block 615, the proximity of the individuals may be tracked. For example, each individual and the user may be associated with a GPS device. The proximity may be a predetermined proximity defined by a distance, a location, or a Bluetooth range. Once the user is within the predetermined proximity of at least one other individual, at block 620, metrics regarding the encounter may be tracked. In some embodiments, at block 625, the location of the group may be determined. For example, the individuals in the group may have a GPS-enabled device that is connected to the network. The network may determine a geographical location of the device. The geographical location may be a series of coordinates such as longitude and latitude. In other embodiments, a more specific description of the location may be available. For example, the geographical location may be associated with the user's home, a mountain range, a shopping center, etc.

In some embodiments, at block 630, the activity of the group may be determined. For example, the group may record their activity on a social media outlet. In another embodiment, once the location of the group is determined, the location may be used to deduce an activity of the group. For example, if the group is located at a mall, it is likely the group is shopping. Additionally, if the group is located at a mountain resort, it is likely the group is skiing. In some embodiments, it may be determined that the group is moving. For example, the group may be participating in a biking trip, hiking in the mountains, or playing a sport.

In some instances, at block 640, the amount of communication between the group may be determined. For example, the devices associated with the users may contain microphones. When the devices are within a predetermined proximity of each other, the microphones may be activated to record the amount of conversation between the individuals. The conversation may be a face-to-face conversation. In other embodiments, the communication between the individuals may be determined independent of a location of the user and the individuals. For example, the user and the individual(s) may be communicating via a phone conversation, SMS conversation, email conversation, social media communication, or the like.

In further embodiments, at block 645, the amount of time the group are within a predetermined distance may be recorded. For example, once the devices associated with the user and at least one other individual are within a predetermined proximity, a timer may start running. At any given time, multiple timers may be activated. For example, a first timer may begin when the user and a first individual are within a predetermined proximity of each other. Then, a second and third timer may begin when a second individual join the group. The second timer may record the time the user and the second individual are within the predetermined proximity. A third timer may record when the user, first and second individual are all within a predetermined proximity of each other. Then, if a third individual joins the group, five timers may be simultaneously running. The fourth timer may track the time the user and the third individual are within a predetermined proximity of each other. The fifth timer may record the amount of time the group (i.e., the user, first individual, second individual and third individual) are within a predetermined proximity of each other, and so on and so forth.

In some embodiments, at block 650, the metrics may be used to generate a score. The score may quantify the time the group spent together. The score may be calculated in a variety of ways. For example, the score may be a scaling score on the basis of 1 through 10 or 1 through 100, etc. The score may average a scaling score of all the metrics. For example, each metric may be given a scaling score. The scaling score of each metric may then be averaged together to rate the experience. The metrics may include the activity, the location, the number of individuals, the communication level and/or the amount of time spent together. In some embodiments, where communication was detected absent a physical proximity of the individuals, an additional score may be generated to account solely for the length of time and the quantity of communication.

In alternative embodiments, at block 650, the metrics may be used to generate an open-ended score. For example, in some instances, each metric may be given an open-ended score and the scores may be cumulated to tally a final score. In still further embodiments, the score may be a weighted score. For example, each metric may have a different importance factor. For example, it may be more important for a user to spend a longer quantity of time with an individual. Therefore, the time metric may receive a scaling factor when the final total is tallied.

In some embodiments, at block 655, the user may set goals. The goals may relate to the scores the user wishes to receive or may be more specific. For example, the user may wish to eat dinner with his family at least three times during the work week. The method 600 may be able to track and determine how often the user was home in time for dinner and ate with the family. The user may set other goals as well, such as helping a child with homework, taking a spouse on a date, taking children on an excursion, having an extended family meal, going out for drinks with his friends, etc.

In some embodiments, at block 660, a report may be generated. The report may compare the scores generated with the goals set by the user. The report may be generated coincidentally when scores are generated and sent to the user, or may be generated at a set time. For example, the user may wish to receive reports daily, weekly, monthly, etc. Once the report is generated, in some instances, at block 670, the report may be transmitted to the user. The report may be transmitted via SMS message, email, phone message, social media, etc. The report may be sent to only the user, or may be sent to all individuals with whom the report concerns.

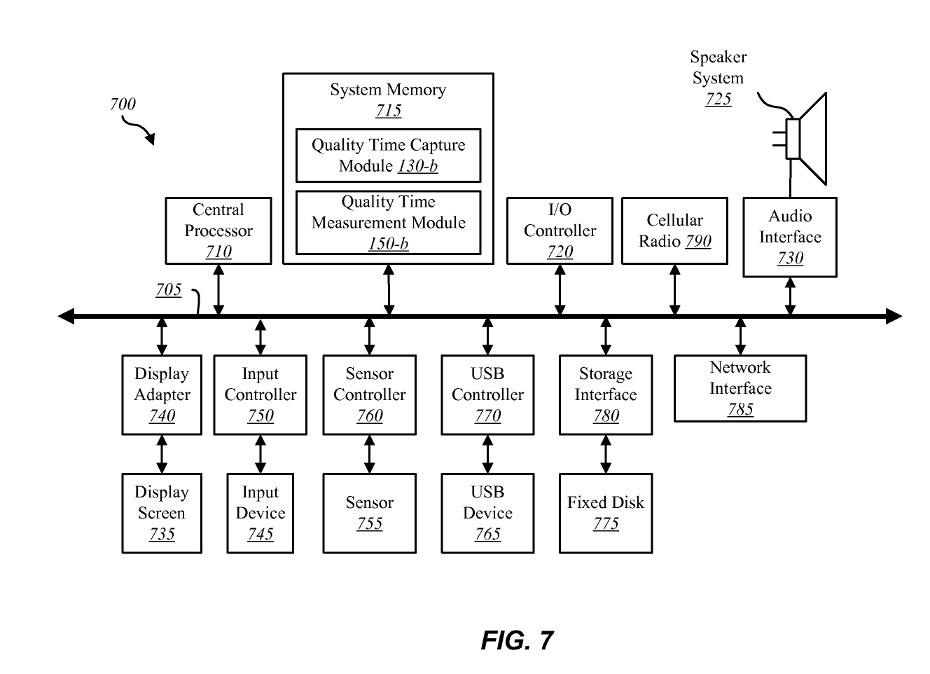

FIG. 7 depicts a block diagram of a computer system 700 suitable for implementing the present systems and methods. The computer system 700 may be an example of the device 105, the computing device 165, the server 145, and/or some combination thereof illustrated in FIG. 1. In one configuration, the computer system 700 may include a bus 705 which interconnects major subsystems of the computer system 700, such as a central processor 710, a system memory 715 (typically RAM, but which may also include ROM, flash RAM, or the like), an input/output controller 720, an external audio device, such as a speaker system 725 via an audio output interface 730, an external device, such as a display screen 735 via display adapter 740, an input device 745 (e.g., remote control device interfaced with an input controller 750), multiple USB devices 765 (interfaced with a USB controller 770), one or more cellular radios 790, and a storage interface 780. Also included are at least one sensor 755 connected to bus 705 through a sensor controller 760 and a network interface 785 (coupled directly to bus 705).

The bus 705 may allow data communication between the central processor 710 and the system memory 715, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, a quality time capture module 135-b and/or a quality time measurement module 150-b to implement the present systems and methods may be stored within the system memory 715. Applications (e.g., application 110) resident with the computer system 700 are generally stored on and accessed via a non-transitory computer readable medium, such as a hard disk drive (e.g., fixed disk 775) or other storage medium. Additionally, applications can be in the form of electronic signals modulated in accordance with the application and data communication technology when accessed via the interface 785.

The storage interface 780, as with the other storage interfaces of the computer system 700, can connect to a standard computer readable medium for storage and/or retrieval of information, such as a fixed disk drive 775. The fixed disk drive 775 may be a part of the computer system 700 or may be separate and accessed through other interface systems. The network interface 785 may provide a direct connection to a remote server via a direct network link to the Internet via a POP (point of presence). The network interface 785 may provide such connection using wireless techniques, including digital cellular telephone connection, Cellular Digital Packet Data (CDPD) connection, digital satellite data connection, or the like.

Many other devices or subsystems (not shown) may be connected in a similar manner (e.g., documents scanners, digital cameras, and so on). Conversely, all of the devices shown in FIG. 7 need not be present to practice the present systems and methods. The devices and subsystems can be interconnected in different ways from that shown in FIG. 7. The aspect of some operations of a system such as that shown in FIG. 7 are readily known in the art and are not discussed in detail in this application. Code to implement the present disclosure can be stored in a non-transitory computer-readable medium such as one or more of system memory 715 or fixed disk 775. The operating system provided on the computer system 700 may be iOS®, ANDROID®, MS-DOS®, MS-WINDOWS®, OS/2®, UNIX®, LINUX®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. A computer-implemented method to quantify time spent with individuals, comprising:
creating a network of at least two individuals;
recording an amount of time the individuals are within a predetermined proximity of each other;
determining whether the individuals are participating in a preferred activity of at least one of the individuals during the time the individuals are within the predetermined proximity of each other;
generating a score based at least in part on the amount of time recorded and the preferred activity; and
transmitting the score to at least one individual of the network.

2. The computer-implemented method of claim 1, wherein creating a network of at least two individuals further comprises:
identifying at least two individuals; and
identifying a GPS-enabled device associated with each individual.

3. The computer-implemented method of claim 2, wherein the GPS-enabled device is one of a mobile phone, a wearable device, or a tablet.

4. The computer-implemented method of claim 1, further comprising:
determining whether the individuals are at a preferred location of at least one of the individuals;
generating a second score based at least in part on the preferred activity, preferred location, and amount of time recorded; and
transmitting the second score to at least one of the individuals of the network.

5. The computer implemented method of claim 1, wherein the predetermined proximity is approximately 0.25 miles.

6. The computer-implemented method of claim 1, further comprising:
determining if the at least two individuals are communicating; and
generating the score based additionally on the communicating between the at least two individuals.

7. The computer-implemented method of claim 6, wherein the communicating may be one of a phone conversation, an SMS conversation, an email conversation, a social media communication, or a face-to-face conversation.

8. The computer implemented method of claim 7, wherein the generated score is reduced when the at least two individuals are not within the predetermined proximity of each other.

9. The computer-implemented method of claim 1, further comprising:
receiving goals from at least one of the individuals, wherein the goals are based at least in part on scores the individual wishes to receive;
generating a report comparing the goals of the at least one of the individuals with the generated scores; and
transmitting the report to the at least one of the individuals.

10. The computer-implemented method of claim 1, wherein the at least two individuals are members of a family-unit.

11. The computer-implemented method of claim 1, wherein the network comprises more than two individuals and each individual that is part of the network is part of a family-unit.

12. The computer-implemented method of claim 11, wherein the generated score is additionally based on the number of individuals in the family-unit that are within the predetermined proximity of each other.

13. An apparatus for quantifying time spent with individuals, comprising:
a processor;
a memory in electronic communication with the processor; and
instructions stored in the memory, the instructions being executable by a processor to:
create a network of at least two individuals;
record an amount of time the individuals are within a predetermined proximity of each other;
determine whether the individuals are participating in a preferred activity of at least one of the individuals during the time the individuals are within a predetermined proximity of each other;
generate a score based at least in part on the amount of time recorded and the preferred activity; and
transmit the score to at least one individual of the network.

14. The apparatus of claim 13, wherein the score is sent as one of an email, an SMS message, a phone call, or a social media post.

15. The apparatus of claim 13, wherein participating in a preferred activity may further include being at a preferred location of one of the individuals.

16. The apparatus of claim 13, wherein the predetermined proximity is approximately 0.25 miles.

17. A computer-program product for quantifying time spent with individuals, the computer-program product comprising a non-transitory computer-readable medium storing instructions executable by a processor to:
create a network of at least two individuals;
record an amount of time the individuals are within a predetermined proximity of each other;
determine whether the individuals are participating in a preferred activity of at least one of the individuals during the time the individuals are within a predetermined proximity of each other;
generate a score based at least in part on the amount of time recorded and the preferred activity; and
transmit the score to at least one individual of the network.

18. The computer-program product of claim 17, wherein the score is sent as one of an email, an SMS message, a phone call, or a social media post.

19. The computer-program product of claim 17, wherein participating in a preferred activity may further include being at a preferred location of one of the individuals.

20. The computer-program product of claim 17, wherein the predetermined proximity is approximately 0.25 miles.
